(19) United States
(12) Patent Application Publication
(10) Pub. No.: US 2018/0074226 A1
(43) Pub. Date: Mar. 15, 2018

(54) METASURFACE

(71) Applicant: HAMAMATSU PHOTONICS K.K., Hamamatsu-shi (JP)

(72) Inventors: Yoshiro NOMOTO, Hamamatsu-shi (JP); Yoshitaka KUROSAKA, Hamamatsu-shi (JP); Kazuyoshi HIROSE, Hamamatsu-shi (JP); Takahiro SUGIYAMA, Hamamatsu-shi (JP); Soh UENOYAMA, Hamamatsu-shi (JP)

(73) Assignee: HAMAMATSU PHOTONICS K.K., Hamamatsu-shi (JP)

(21) Appl. No.: 15/701,537

(22) Filed: Sep. 12, 2017

(30) Foreign Application Priority Data
Sep. 14, 2016 (JP) 2016-179426

(51) Int. Cl. G02B 1/00; G02B 5/00; G02F 1/19

(52) U.S. Cl. CPC G02B 1/002; G02F 2202/30; G02F 1/19; G02B 5/008

(57) ABSTRACT

A metasurface includes a substrate including a light input surface into which input light is input and a light output surface facing the light input surface, and a plurality of V-shaped antenna elements disposed on the light output surface of the substrate and including a first arm and a second arm continuing on one end of the first arm. The each of the V-shaped antenna elements has a thickness in a range of 100 nm to 400 nm.

### TECHNICAL FIELD

The technical field relates to a metasurface.

### BACKGROUND

As described in, for instance, Non-patent Literature (Nanfang Yu, et al. “Light Propagation with Phase Discontinuities: Generalized Laws of Reflection and Refraction,” SCIENCE, VOL 334, pp. 333-337, 21 Oct. 2011), a metasurface for modulating and outputting input light is known. The metasurface described in this document includes a Si substrate including a light input surface into which input light is input and a light output surface facing the light input surface, and a plurality of V-shaped antenna elements disposed on the light output surface of the Si substrate. In this metasurface, thicknesses of the V-shaped antenna elements are generally set to 30 nm to 50 nm.

### SUMMARY

In one embodiment, a metasurface includes: a substrate including a light input surface into which input light is input and a light output surface facing the light input surface; and a plurality of V-shaped antenna elements disposed on the light output surface of the substrate and including a first arm and a second arm continuing on one end of the first arm. The each of the V-shaped antenna elements has a thickness in a range of 100 nm to 400 nm.

### BRIEF DESCRIPTION OF THE DRAWINGS

FIG. 1 is a top view illustrating a constitution of a metasurface according to an embodiment.

FIG. 2 is a partial sectional view taken along line II-II of FIG. 1.

FIG. 3A is a view for defining a shape of a V-shaped antenna element having a basic structure.

FIG. 3B is a view for defining a shape of a V-shaped antenna element having an inverse symmetric structure.

FIG. 4A is a graph illustrating results analyzed by changing an antenna thickness with respect to an intensity of output light on the metasurface.

FIG. 4B is an enlarged graph illustrating a part of FIG. 4A.

FIG. 5 is a graph illustrating results analyzed by changing the antenna thickness with respect to the intensity of output light on the metasurface.

FIG. 6A is a graph illustrating results analyzed by changing the antenna thickness with respect to the intensity of output light on the metasurface.

FIG. 6B is an enlarged graph illustrating a part of FIG. 6A.

FIG. 7 is a partial sectional view of a metasurface according to a modification.

FIG. 8 is a graph illustrating results analyzed by changing the antenna thickness with respect to the intensity of output light on the metasurface according to the modification.

### DETAILED DESCRIPTION

In the following description, identical or equivalent elements are given the same reference signs, and duplicate description thereof will be omitted.

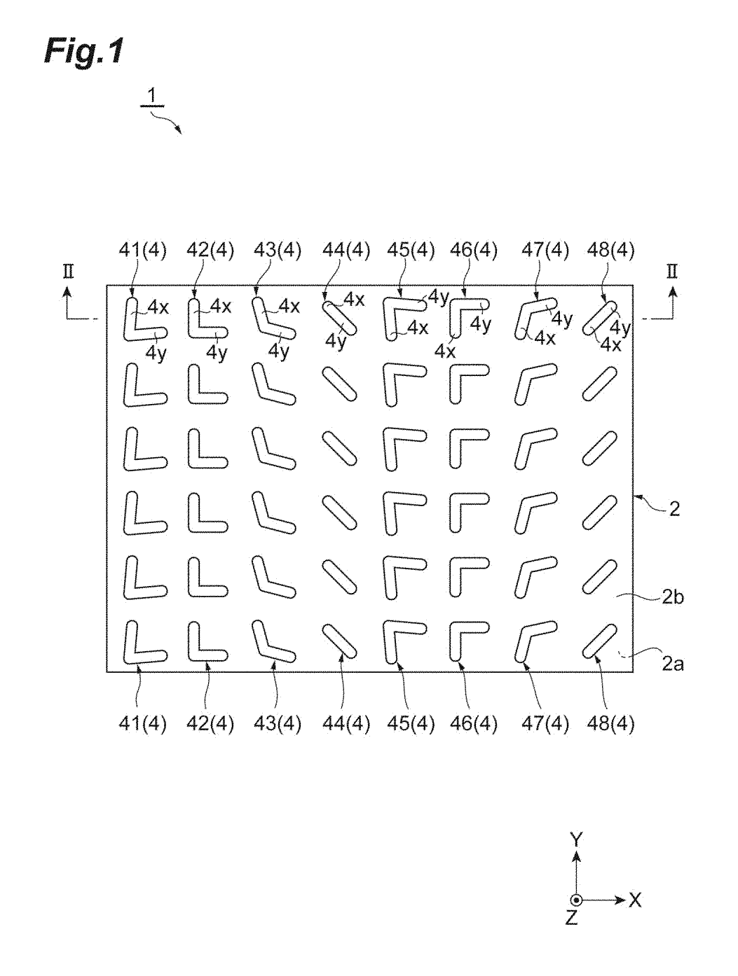

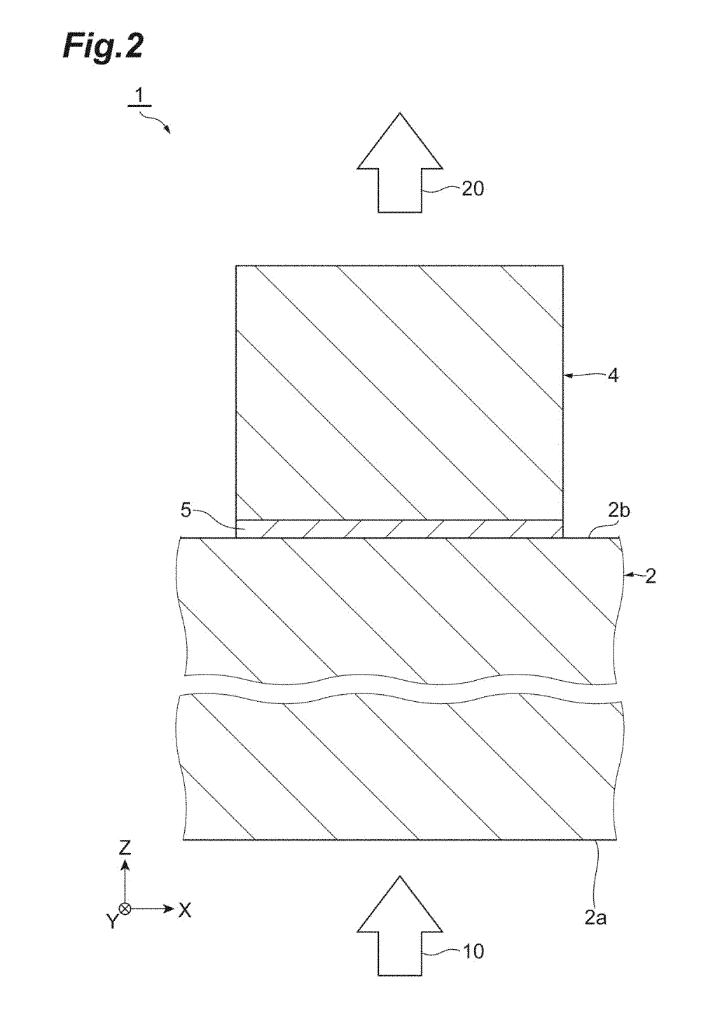

FIG. 1 is a schematic top view illustrating a constitution of a metasurface according to an embodiment. FIG. 2 is a partial sectional view taken along line II-II of FIG. 1. As illustrated in FIGS. 1 and 2, a metasurface 1 modifies at least any of a phase, an amplitude, and polarization of input light 10 to output desired output light 20. In this case, the metasurface 1 performs desired modification on the phase of the input light 10 in individual elements (V-shaped antenna elements 4 to be described below) that are two-dimensionally arranged, and thereby a desired optical device can be formed. The metasurface 1 is generally known as a structure of a two-dimensional plate formed of a metamaterial.

The metasurface 1 can be used as at least any of, for instance, a condenser lens, an axicon lens, a chromatic aberration-free lens, a spherical aberration-free lens, a λ/4 wavelength plate, a λ12 wavelength plate, an optical vortex generating plate, and a hologram element. The metasurface 1 can be used for at least any of, for instance, output light control of a micro-condenser lens, a micro-coupling device, a device (a polarization splitter or the like) having polarization selectivity and wavelength selectivity, and a photonic crystal laser of a detector array group. A thickness of the metasurface 1 can be set to be less than or equal to a wavelength of the input light 10. In the following description, a thickness direction of the metasurface 1 (a direction that is substantially perpendicular to a light output surface 2b of a substrate 2) will be defined as a “Z-axial direction,” one direction perpendicular to the Z-axial direction will be defined as an “X-axial direction,” and a direction perpendicular to both the X-axial direction and the Z-axial direction will be defined as a “Y-axial direction.”

The metasurface 1 of the present embodiment is a transparent plasmon type metasurface. In the shown example, the metasurface 1 is an optical device acting as a condenser lens. The metasurface 1 outputs the output light 20 that is condensed to a desired focal position when the input light 10 is input. The metasurface 1 includes the substrate 2 and the plurality of V-shaped antenna elements 4.

The substrate 2 presents a flat plate shape. The substrate 2 is a GaAs substrate formed of gallium arsenide (GaAs), a glass substrate formed of glass, a Si substrate formed of silicon (Si), III-V semiconductor substrates (wafers) such as GaN, AlN, InP and GaP substrates (wafers), III-V mixed semiconductor substrates (wafers), SOI(Silicon On Insulator) substrates(wafers), or SOQ(Silicon On Quartz) substrates (wafers). In the metasurface 1 having the GaAs substrate as the substrate 2, the input light 10 including a wavelength of at least 880 nm to 40 μm is modulated, and is for instance near infrared radiation or middle infrared radiation. In the metasurface 1 having the glass substrate as the substrate 2, the input light 10 including a wavelength of at least 200 nm to 40 μm is modulated, and is for instance ultraviolet radiation, visible light, or near infrared radiation or middle infrared radiation. In the metasurface 1 having the Si substrate as the substrate 2, the input light 10 including a wavelength of at least 1 μm in to 40 μm is modulated, and is for instance the near infrared radiation or the middle infrared radiation.

The substrate 2 includes a light input surface 2a into which the input light 10 is input, and a light output surface 2b to which the output light 20 is output. The light input surface 2a is one principal surface of the substrate 2. The light output surface 2b is opposite to the light input surface 2a. The light output surface 2b is the other principal surface of the substrate 2. A thickness of the substrate 2 is, for instance, from 0.5 mm to 10 mm.

The V-shaped antenna elements 4 are provided at the light output surface 2b side of the substrate 2. In other words, the V-shaped antenna elements 4 are arranged on the light output surface 2b of the substrate 2. Here, the V-shaped antenna elements 4 are disposed on the light output surface 2b via an adhesive layer 5.

The adhesive layer 5 is formed of titanium (Ti), chromium (Cr), platinum (Pt), or at least one thereof. A thickness of the adhesive layer 5 is, for instance, from 5 nm to 10 nm. The adhesive layer 5 enhances adhesion of the V-shaped antenna elements 4 to the substrate 2, and suppresses detachment of the V-shaped antenna elements 4. For example, the adhesive layer 5 has adhesion that is stronger than adhesion between the substrate 2 and the V-shaped antenna element 4 with respect to each of the substrate 2 and the V-shaped antenna element 4. The adhesion is synonymous with attachability, attachment force, adhesive force, or the like.

The V-shaped antenna elements 4 are so-called positive type elements. The each of the V-shaped antenna elements 4 convex disposed on the substrate 2. The V-shaped antenna elements 4 are formed of a metal such as gold (Au). The V-shaped antenna elements 4 are provided to bulge on the light output surface 2b of the substrate 2 in the Z-axial direction. The each of the V-shaped antenna elements 4 has a thickness (a dimension in the Z direction) in range of 100 nm to 400 nm. The each of the V-shaped antenna element 4 may have the thickness in range of 100 nm to 200 nm. Hereinafter, the dimension of the V-shaped antenna element 4 in the Z direction is referred to as an “antenna thickness.”

160,000 V-shaped antenna elements 4 are arranged in an area of 100 μm×100 μm on the light output surface 2b of the substrate 2. Each of the V-shaped antenna elements 4 has a first arm 4x having a projection shape, and a second arm 4y that is continuous to one end of the first arm 4x and has a projection shape.

The plurality of V-shaped antenna elements 4 include eight types of first to eighth antenna elements 41 to 48 having V-shaped structures different in shape from one another. To be specific, the plurality of V-shaped antenna elements 4 include first to fourth antenna elements 41 to 44 that are V-shaped structures having four types of basic structures, and fifth to eighth antenna elements 45 to 48 that are V-shaped structures having inverse symmetric structures in which the four types of basic structures are inverted with respect to the X axis.

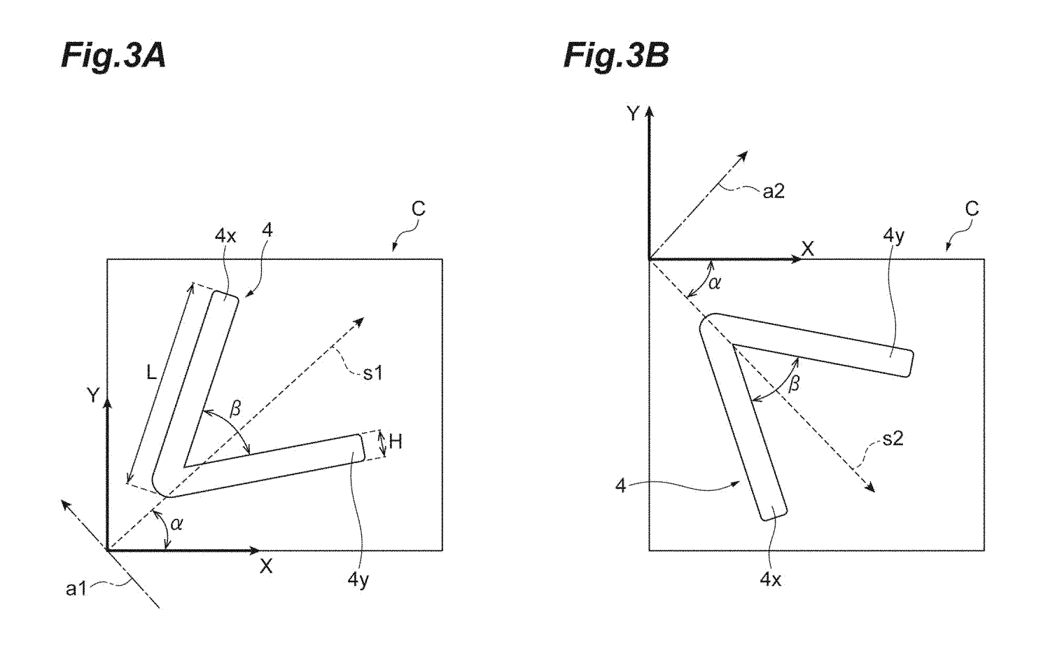

FIG. 3A is a view for defining a shape of the V-shaped antenna element 4 having a basic structure. FIG. 3B is a view for defining a shape of the V-shaped antenna element 4 having an inverse symmetric structure. In FIG. 3, a unit cell C, that is, a rectangular plate-shaped region including only one V-shaped antenna element 4 within the metasurface 1, is shown. The unit cell C has sides in the X-axial and Y-axial directions. Here, a size of the unit cell C is 240 nm×240 nm (dimensions of the X-axial and Y-axial directions are both 240 nm).

As illustrated in FIG. 3A, in the V-shaped antenna elements 4 (the first to fourth antenna elements 41 to 44) having the basic structures, an axis s1 of symmetry which has an angle α with respect to an X axis and an axis a1 of asymmetry perpendicular to the axis s1 of symmetry are set. The angle α is 45 degrees. The angle by which polarization of the output light 20 is rotated in polarization of the input light 10 can be determined based on the angle α. When the angle α is 45 degrees, the polarization of the output light 20 is rotated 90 degrees with respect to the polarization of the input light 10. The V-shaped antenna element 4 having the basic structure presents a line symmetrical shape via the axis s1 of symmetry.

In the following description, an angle formed by the first arm 4x and the second arm 4y will be defined as an inter-arm angle β, a longitudinal length of each of the first arm 4x and the second arm 4y will be defined as an arm length L, and a width of each of the first arm 4x and the second arm 4y will be defined as an arm width H.

As illustrated in FIG. 3B, the V-shaped antenna elements 4 (the fifth to eighth antenna elements 45 to 48) having the inverse symmetric structures are structures in which the basic structures of FIG. 3A are inverted with respect to the X axis. In the V-shaped antenna element 4 having the inverse symmetric structure, an axis s2 of symmetry perpendicular to the axis s1 of symmetry (see FIG. 3A) and an axis a2 of asymmetry perpendicular to the axis s2 of symmetry are set. Like the axis s1 of symmetry, the axis s2 of symmetry has an angle α with respect to the X axis. The V-shaped antenna element 4 having the inverse symmetric structure presents a line symmetrical shape via the axis s2 of symmetry. In the V-shaped antenna element 4 having the inverse symmetric structure, phase modulation of +180 degrees is obtained with respect to the V-shaped antenna element 4 having the basic structure.

Returning to FIG. 1, an angle formed by the first arm 4x and the second arm 4y in each of the plurality of V-shaped antenna elements 4 is greater than or equal to 70 degrees. That is, the inter-arm angles β of the first to eighth antenna elements 41 to 48 are not less than 70 degrees and not more than 180 degrees. Thus, the inter-arm angles β of the first to eighth antenna elements 41 to 48 are an angle in a range of 70 degrees to 180 degrees. The arm widths H of the first to eighth antenna elements 41 to 48 are equal to one another, and are for instance 40 nm.

The inter-arm angle β of the first antenna element 41 is 75 degrees. The arm length L of the first antenna element 41 is longer than those of the second to fourth antenna elements 42 to 44. The inter-arm angle β of the second antenna element 42 is 90 degrees. The aim length L of the second antenna element 42 is shorter than that of the first antenna element 41, and is longer than those of the third and fourth antenna elements 43 and 44.

The inter-arm angle β of the third antenna elements 43 is 120 degrees. The arm length L of the third antenna element 43 is shorter than those of the first and second antenna elements 41 and 42, and is longer than that of the fourth antenna element 44. The inter-arm angle β of the fourth antenna element 44 is 180 degrees. That is, the fourth antenna element 44 has a shape in which the first arm 4x and the second arm 4y extend straight along the same straight line. The arm length L of the fourth antenna element 44 is shorter than those of the first to third antenna elements 41 to 43.

The fifth antenna element 45 has the inverse symmetric structure of the first antenna element 41 with respect to the X axis. The inter-arm angle β of the fifth antenna element 45 is 75 degrees. The arm length L of the fifth antenna element 45 is longer than those of the sixth to eighth antenna elements 46 to 48. The sixth antenna element 46 has the inverse symmetric structure of the second antenna element 42 with respect to the X axis. The inter-arm angle β of the sixth antenna element 46 is 90 degrees. The arm length L of the sixth antenna element 46 is shorter than that of the fifth antenna element 45, and is longer than those of the seventh and eighth antenna elements 47 and 48.

The seventh antenna element 47 has the inverse symmetric structure of the third antenna element 43 with respect to the X axis. The inter-arm angle β of the seventh antenna element 47 is 120 degrees. The arm length L of the seventh antenna element 47 is shorter than those of the fifth and sixth antenna elements 45 and 46, and is longer than that of the eighth antenna element 48. The eighth antenna element 48 has the inverse symmetric structure of the fourth antenna element 44 with respect to the X axis. The inter-arm angle β of the eighth antenna element 48 is 180 degrees. That is, the eighth antenna element 48 has a shape in which the first arm 4x and the second arm 4y extend straight along the same straight line. The arm length L of the eighth antenna element 48 is shorter than those of the fifth to seventh antenna elements 45 to 47.

The plurality of V-shaped antenna elements 4 are configured to be usable as the phase modulation optical devices. That is, the first to eighth antenna elements 41 to 48 are identical in intensity of the output light 20 which is output according to input of the input light 10. The first to eighth antenna elements 41 to 48 perform phase modulation of 0 to 2π on the input light 10.

The first to eighth antenna elements 41 to 48 satisfy the following formula (1), and are arranged on the light output surface 2b of the substrate 2 such that a desired phase difference occurs at a desired position. Thereby, when the input light 10 is input from the light input surface 2a of the substrate 2, a condenser lens for condensing the output light 20 at a desired focal position can be formed. In the following formula (1), x and y indicate coordinates within a plane, φ indicates an amount of phase shift in the coordinates (x, y), and f indicates a desired focal distance.

$$ϕ ( x , y ) = \frac{2 π}{λ} ( \sqrt{{x}^{2} + {y}^{2} + {f}^{2}} - f ) \qquad ( 1 )$$

When the metasurface 1 described above is manufactured, the substrate 2 is prepared first. A resist layer is formed on the light output surface 2b of the substrate 2. An electron beam is applied to the resist layer using an electron beam lithography device, so that a printing pattern corresponding to the shapes of the V-shaped antenna elements 4 is exposed. Metal layers are vapor-deposited on the substrate 2 and the resist layer. Here, a Ti layer and a Au layer are vapor-deposited in that order. The resist layer is removed by a liftoff process along with the metal layers on the resist layer. Thereby, the metasurface 1 is obtained. The metal layers vapor-deposited on the light output surface 2b of the substrate 2 constitute the adhesive layer 5 and the V-shaped antenna elements 4.

In the metasurface 1 manufactured in this way, as the antenna thickness increases in manufacturing, it is more difficult to provide the V-shaped antenna elements 4 on the substrate 2. When the antenna thickness is not less than 400 nm, the thicknesses of the V-shaped antenna elements 4 can be excessively increased with respect to the substrate 2, and thus it is impractical to provide the V-shaped antenna elements 4 for the substrate 2. It is difficult to vapor-deposit the metal layers on the exposed resist layer. On the other hand, when the antenna thickness is equal to or less than 200 nm, the V-shaped antenna elements 4 can be reliably and easily disposed on the substrate 2 in manufacturing.

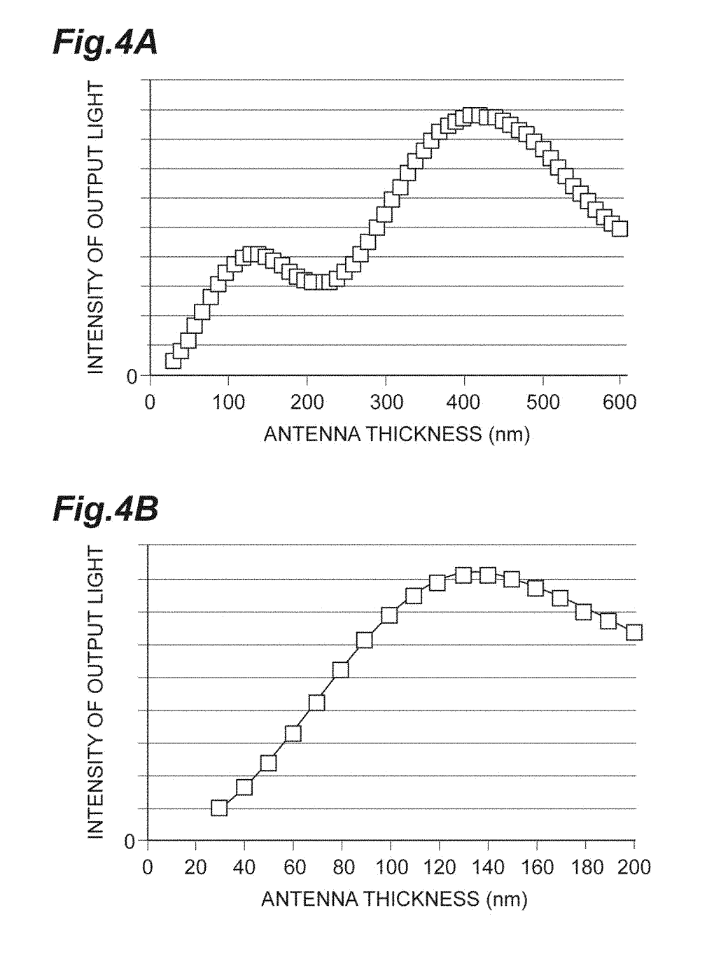

FIG. 4A is a graph illustrating results analyzed by changing an antenna thickness with respect to the intensity of the output light 20 on the metasurface 1. FIG. 4B is an enlarged graph illustrating a part of FIG. 4A. Here, the metasurface 1 having the GaAs substrate as the substrate 2 is set as a target of analysis. The adhesive layer 5 has a thickness of 5 nm. The input light 10 is light that is orthogonally input from the light input surface 2a of the substrate 2. The input light 10 is light having a wavelength of 940 nm. The intensity of the output light 20 is synonymous with conversion efficiency of light caused by the V-shaped antenna elements 4. The intensity of the output light 20 is also referred to as intensity of crossed-scattered light (a crossed electric field intensity).

As illustrated in FIG. 4A, in the metasurface 1 having the GaAs substrate as the substrate 2, when the antenna thickness is increased with respect to a typical antenna thickness (30 nm to 50 nm), it is found that the intensity of the output light 20 has a tendency to increase. As illustrated in 4B, it is found that, when the antenna thickness increases in a range in which the antenna thickness is smaller than 100 nm, the intensity of the output light 20 greatly (sharply) increases. It is found that a degree of change (a slope) of the intensity of the output light 20 for the antenna thickness is great in a range other than the range in which the antenna thickness is smaller than 100 nm.

As illustrated in FIGS. 4A and 4B, in a range in which the antenna thickness is equal to or less than 400 nm, a plurality of (two) peaks relevant to the intensity of the output light 20 are present. When the antenna thickness is 400 nm, the intensity of the output light 20 is a peak. In a range in which the antenna thickness is equal to or less than 200 nm, the intensity of the output light 20 is high when the antenna thickness ranges from 100 nm to 200 nm, and the intensity of the output light 20 is a peak when the antenna thickness is 140 mm The intensity of the output light 20 when the antenna thickness is 140 nm is 7.9 times the intensity of the output light 20 when the antenna thickness is 30 nm.

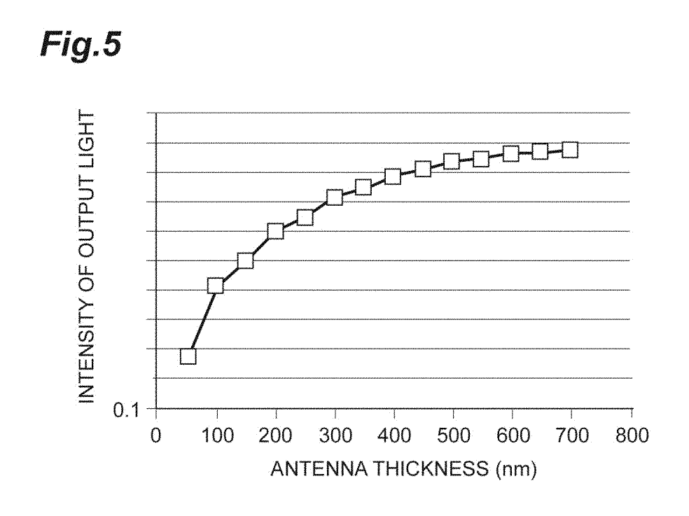

FIG. 5 is a graph illustrating results analyzed by changing an antenna thickness with respect to the intensity of the output light 20 on the metasurface 1. Here, the metasurface 1 having the Si substrate as the substrate 2 is set as a target of analysis. The adhesive layer 5 has a thickness of 10 nm. The input light 10 is light that is orthogonally input from the light input surface 2a of the substrate 2. The input light 10 is light having a wavelength of 8 μm.

As illustrated in FIG. 5, it is found that, when the antenna thickness is made greater than a typical antenna thickness in the metasurface 1 having the Si substrate as the substrate 2, the intensity of the output light 20 has a tendency to increase. Especially, it is found that, when the antenna thickness increases in the range in which the antenna thickness is smaller than 100 nm, the intensity of the output light 20 is greatly enhanced. It is found that a degree of change of the intensity of the output light 20 for the antenna thickness is great in a range other than the range in which the antenna thickness is smaller than 100 nm. In a range in which the antenna thickness is equal to or less than 400 nm, the intensity of the output light 20 sharply increases in proportion to the antenna thickness, and then smoothly increases.

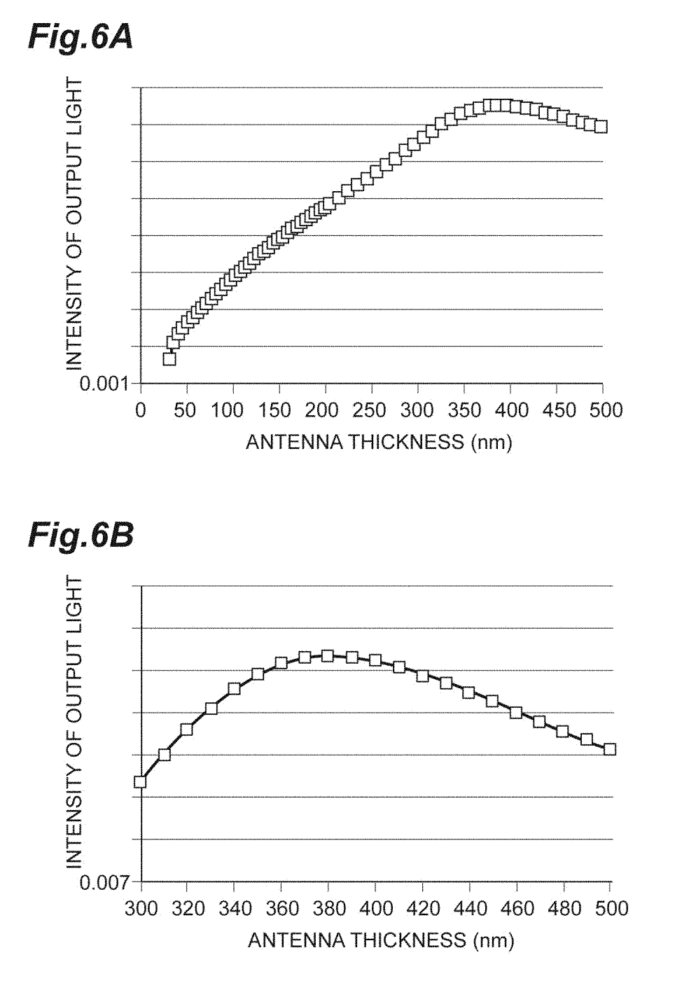

FIG. 6A is a graph illustrating results analyzed by changing an antenna thickness with respect to the intensity of the output light 20 on the metasurface 1. FIG. 6B is an enlarged graph illustrating a part of FIG. 6A. Here, the metasurface 1 having the glass substrate as the substrate 2 is set as a target of analysis. The adhesive layer 5 has a thickness of 5 nm. The input light 10 is light that is orthogonally input from the light input surface 2a of the substrate 2 and has a wavelength of 940 nm.

As illustrated in FIG. 6A, it is found that, when the antenna thickness is made greater than a typical antenna thickness in the metasurface 1 having the glass substrate as the substrate 2, the intensity of the output light 20 has a tendency to increase. Especially, it is found that, as the antenna thickness increases in a range in which the antenna thickness is smaller than 50 nm, the intensity of the output light 20 is greatly enhanced. It is found that a degree of change of the intensity of the output light 20 for the antenna thickness is great in a range other than the range in which the antenna thickness is smaller than 50 nm.

As illustrated in FIGS. 6A and 6B, in a range in which the antenna thickness is equal to or less than 400 nm, the intensity of the output light 20 sharply increases in proportion to the antenna thickness, and then smoothly increases to reach a peak. When the antenna thickness is 380 nm in the range in which the antenna thickness is equal to or less than 400 nm, the intensity of the output light 20 is a peak. The intensity of the output light 20 when the antenna thickness is 380 nm is 27 times the intensity of the output light 20 when the antenna thickness is 30 nm.

As shown in the analyzed results of FIGS. 4 to 6 described above, it was found that, since the intensity of the output light 20 is synonymous with conversion efficiency of light caused by the V-shaped antenna elements 4, when the antenna thickness is greater than 30 nm to 50 nm that is the typical antenna thickness, the conversion efficiency has a tendency to increase. Especially, it was found that, in the range smaller than 100 nm, with the increase of the antenna thickness, the conversion efficiency greatly increases (a degree of increment of the conversion efficiency is great) in some cases. This is considered to be because, since the typical antenna thickness is smaller than a thickness caused by a skin effect of the V-shaped antenna elements 4, a region to which electrons flow can be increased by increasing the antenna thickness, and efficiency of dipole radiation can increase. Therefore, when the antenna thickness is equal to or more than 100 nm, the conversion efficiency is dramatically higher than the case of the typical antenna thickness. That is, it is found that the conversion efficiency can be effectively improved. On the other hand, there are actual situations in which, as the antenna thickness increases in manufacturing, it is difficult to provide the V-shaped antenna elements 4 on the substrate 2, and when the antenna thickness is greater than 400 nm, it is impractical to provide the V-shaped antenna elements 4 on the substrate

In the metasurface 1 of the present embodiment, the antenna thickness ranges from 100 nm to 400 nm. Thereby, an improvement in the conversion efficiency of light caused by the V-shaped antenna elements 4 can be realized. The conversion efficiency of light caused by the V-shaped antenna elements 4 can be significantly enhanced compared to the case of the typical antenna thickness.

In the metasurface 1, only the antenna thickness may range from 100 nm to 200 nm. When the antenna thickness is equal to or less than 200 nm, the V-shaped antenna elements 4 can be reliably provided for the substrate 2. For example, when the antenna thickness is equal to or less than 200 nm, the V-shaped antenna elements 4 can be reliably and easily disposed on the substrate 2 compared to the case in which the antenna thickness is greater than that. Accordingly, in this case, the improvement of the conversion efficiency of light caused by the V-shaped antenna elements 4 can be reliably realized.

As the inter-arm angle β formed by the first arm 4x and the second arm 4y in the V-shaped antenna element 4 becomes smaller, it is difficult to form the V shape of the V-shaped antenna element 4 in manufacturing. For example, in the V-shaped antenna elements having inter-arm angles β of 40 degrees and 60 degrees, a printing pattern is spread by a proximity effect of an electron beam when the electron beam is applied, and thus it is difficult to form a shape as in a design drawing. In the V-shaped antenna elements having inter-arm angles β of 40 degrees and 60 degrees, the V shapes sometimes easily collapse or become triangular shapes rather than the V shapes when actually manufactured. In this respect, in the metasurface 1 of the present embodiment, the inter-arm angle β is equal to or more than 70 degrees. Thus, the V-shaped antenna elements 4 can be easily manufactured.

In the metasurface 1, the substrate 2 is at least one of the GaAs substrate, the glass substrate, the Si substrate, III-V semiconductor substrates, III-V mixed semiconductor substrates, SOT substrates, and SOQ substrates. Thus, at least one of the GaAs substrate, the glass substrate, the Si substrate, III-V semiconductor substrates, III-V mixed semiconductor substrates, SOI substrates, and SOQ substrates can be applied as the substrate 2.

In the metasurface 1, the each of the V-shaped antenna elements 4 is the convex disposed on the substrate 2. Thereby, in the metasurface 1 having the V-shaped antenna elements 4 formed as so-called positive type elements, the conversion efficiency of light caused by the V-shaped antenna elements 4 can be improved.

As described above, the metasurface 1 is configured to be usable as the phase modulation optical device. That is, the first to eighth antenna elements 41 to 48 are identical in the intensity of the output light 20 that is output according to the input of the input light 10. The first to eighth antenna elements 41 to 48 perform phase modulation of 0 to 2π on the input light 10. Therefore, according to the metasurface 1, the conversion efficiency of light caused by the V-shaped antenna elements 4 can be improved while securing an ability to modulate phases of 0 to 2π.

In the metasurface 1, the plurality of V-shaped antenna elements 4 are formed using the inverse symmetric structure. Thereby, the phase modulation of 0 to 2π of the input light 10 can be easily realized. In the metasurface 1, the unit cells C are arranged with adequate space, and thereby an arbitrary wavefront of the output light 20 can be formed.

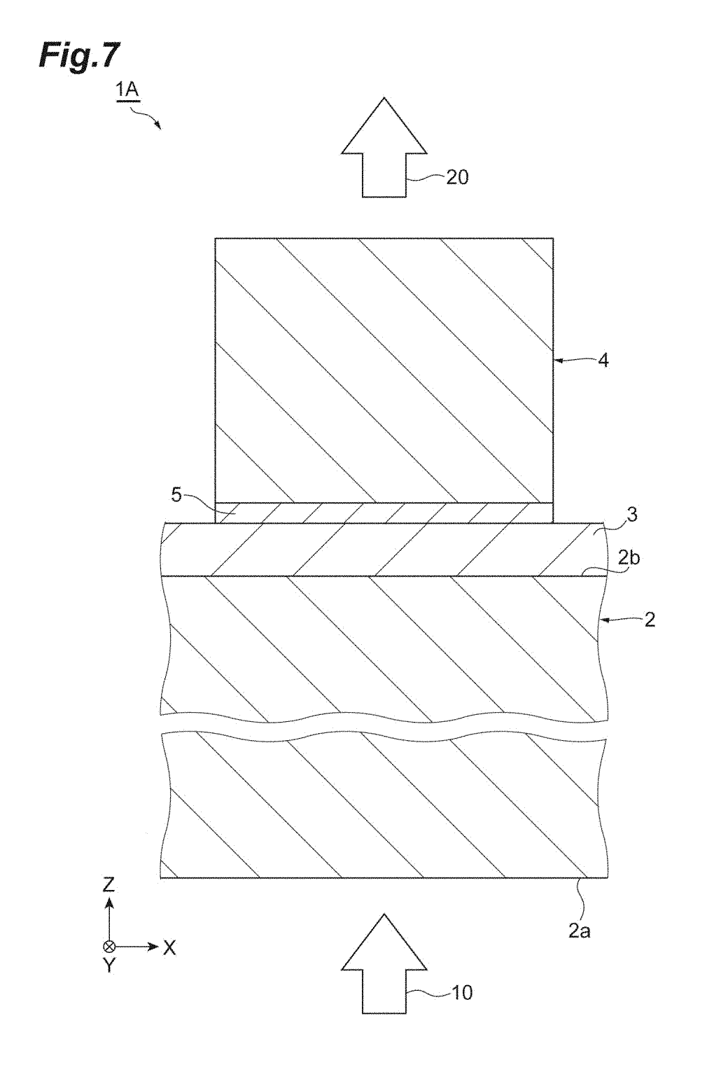

FIG. 7 is a partial sectional view of a metasurface 1A according to a modification. The metasurface 1A according to the modification includes an interlayer 3 between the light output surface 2b of the substrate 2 and the V-shaped antenna elements 4 in a thickness direction. The interlayer 3 has a lower refractive index than the substrate 2. The refractive index is a ratio of a speed of light in vacuum to a speed of light in a material of the interlayer 3. The interlayer 3 is a layer including a SiN layer formed of SiN (silicon nitride), a TiO₂ layer formed of TiO₂ (titanium oxide), a HfO₂ layer formed of HfO₂ (hafnium oxide), a Ta₂O₅ layer formed of Ta₂O₅ (tantalum pentoxide), a Nb₂O₅ layer formed of Nb₂O₅ (niobium pentoxide), an Al₂O₃ layer formed of Al₂O₃ (aluminum oxide), a SiO₂ layer formed of SiO₂(silicon dioxide), or at least one thereof The SiN layer includes a Si₃N₄ layer formed of Si₃N₄.

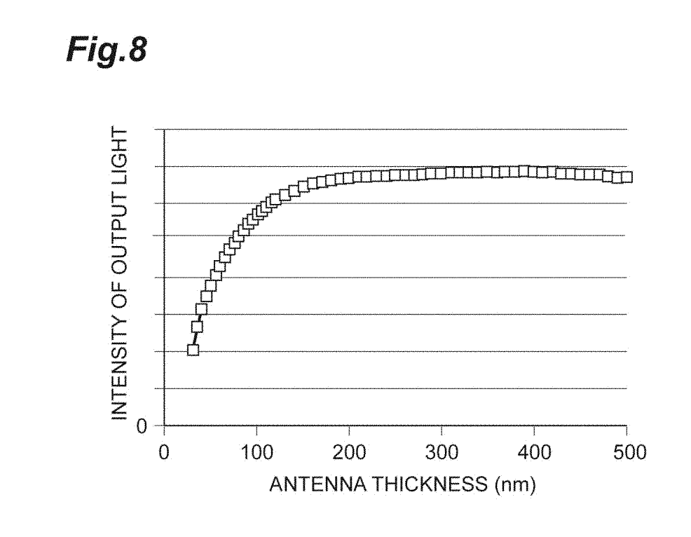

FIG. 8 is a graph illustrating results analyzed by changing the antenna thickness with respect to the intensity of output light 20 on the metasurface 1 A according to the modification. Here, the metasurface 1A having the GaAs substrate as the substrate 2 is set as a target of analysis. A thickness of the interlayer 3 is 90 nm, and a thickness of the adhesive layer 5 is 5 nm. The input light 10 is light that has a wavelength of 940 nm and is orthogonally input from the light input surface 2a of the substrate 2.

As illustrated in FIG. 8, even in the metasurface 1A, it is found that the intensity of the output light 20 has a tendency to increase when the antenna thickness is greater than the typical antenna thickness. Especially, it is found that, when the antenna thickness increases in a range in which the antenna thickness is smaller than 100 nm, the intensity of the output light 20 is greatly enhanced. In a range in which the antenna thickness is equal to or less than 400 nm, the intensity of the output light 20 sharply increases in proportion to the antenna thickness, and then smoothly increases to reach a peak. When the antenna thickness is 370 nm, the intensity of the output light 20 reaches a peak. The intensity of the output light 20 when the antenna thickness is 370 nm is 11.5 times the intensity of the output light 20 when the antenna thickness is 30 nm.

As shown in the analyzed results of FIG. 8, even in the metasurface 1A having the interlayer 3, it is found that an effect in which the conversion efficiency of light can be realized by setting the antenna thickness to 100 nm to 400 nm is exhibited.

While the embodiment has been described, the present invention(s) is not limited to the above embodiment, and may be modified without changing the gist described in each claim or be applied to other embodiments. For example, an error in designing, measuring or manufacturing is included in each of the above numerical values.

In the above embodiment, the each of the V-shaped antenna elements 4 may be concave formed on the metal layers disposed on the substrate 2. To be specific, the V-shaped antenna elements 4 are so-called negative type elements. The V-shaped antenna elements 4 may be provided to be recessed in the metal layers disposed on the light output surface 2b of the substrate 2 via the adhesive layer 5 in the Z-axial direction. The metal layers are each formed of a metal such as gold (Au). A depth (a dimension in the Z direction) of each of the V-shaped antenna elements 4 may range from 100 nm to 400 nm or from 100 nm to 200 nm. Thus, the each of the V-shaped antenna elements 4 may have a depth in range of 100 nm to 400 nm or 100 nm to 200 nm. In this case, in the metasurface 1 having the V-shaped antenna elements 4 formed as so-called negative type elements, the improvement of the conversion efficiency of light caused by the V-shaped antenna elements 4 can be realized.

The plurality of V-shaped antenna elements 4 in the embodiment may include fifth to eighth antenna elements in an inverse symmetric structure formed by inverting the first to fourth antenna elements 41 to 44 with respect to the Y axis instead of the fifth to eighth antenna elements 45 to 48 in the inverse symmetric structure formed by inverting the first to fourth antenna elements 41 to 44 with respect to the X axis.

According to an embodiment, the metasurface capable of realizing the improvement of the conversion efficiency of light caused by the V-shaped antenna elements can be provided.

What is claimed is:

1. A metasurface comprising:
a substrate including a light input surface into which input light is input and a light output surface facing the light input surface; and
a plurality of V-shaped antenna elements disposed on the light output surface of the substrate and including a first arm and a second arm continuing on one end of the first arm,
wherein a each of the V-shaped antenna elements has a thickness in a range of 100 nm to 400 nm.

2. The metasurface according to claim 1, wherein the each of the V-shaped antenna elements has the thickness in a range of 100 nm to 200 nm.

3. The metasurface according to claim 1, wherein the each of the V-shaped antenna elements has an angle formed by the first and second arms in range of 70 degrees to 180 degrees.

4. The metasurface according to claim 2, wherein the each of the V-shaped antenna elements has an angle formed by the first and second arms in range of 70 degrees to 180 degrees.

5. The metasurface according to claim 1, Wherein the substrate is at least one of a GaAs substrate, a glass substrate, and a Si substrate.

6. The metasurface according to claim 2, wherein the substrate is at least one of a GaAs substrate, a glass substrate, and a Si substrate.

7. The metasurface according to claim 3, wherein the substrate is at least one of a GaAs substrate, a glass substrate, and a Si substrate.

8. The metasurface according to claim 4, wherein the substrate is at least one of a GaAs substrate, a glass substrate, and a Si substrate.

9. The metasurface according to claim 1, wherein the each of the V-shaped antenna elements is convex disposed on the substrate.

10. The metasurface according to claim 1, wherein the each of the V-shaped antenna elements is concave formed in metal layers disposed on the substrate.
